(19) United States
(12) Patent Application Publication
(10) Pub. No.: US 2014/0358990 A1
(43) Pub. Date: Dec. 4, 2014

(54) SYSTEM AND METHODS TO FACILITATE ACCESS AND INTERACTION WITH A MOBILE DEVICE EMPLOYING A PERSONAL COMPUTER

(71) Applicant: Nvidia Corporation, Santa Clara, CA (US)

(72) Inventors: Jen-Hsun Huang, Santa Clara, CA (US); Hassane S. Azar, Santa Clara, CA (US); Arman Toorians, Santa Clara, CA (US); Philip J. Carmack, Santa Clara, CA (US)

(21) Appl. No.: 13/908,779

(22) Filed: Jun. 3, 2013

(51) Int. Cl. H04L 29/06

(52) U.S. Cl. CPC H04L 67/42
USPC 709/203

(57) ABSTRACT

A communications system includes a mobile device that is coupled to a network and has a mobile application requiring fulfillment and a personal computer that is coupled to the network and has computer data entry and display capabilities. Additionally, the communications system includes a mobile applications processor that is coupled to the personal computer and provides a mobile device interaction, wherein the mobile device interaction includes fulfillment of the mobile application with the computer data entry and display capabilities. A method of operating a communications system and a method of fulfilling mobile applications are also provided.

### TECHNICAL FIELD

This application is directed, in general, to communications and, more specifically, to a communications system, a method of operating a communications system and a method of fulfilling mobile applications.

### BACKGROUND

The latest advances in mobile and wireless technologies have enabled mobile devices, such as smartphones and tablets (i.e., computer tablets), to provide a wider range of new uses and interoperability between electronic devices. A typical example is the ability of a mobile device to stream content from a personal computer associated with watching a movie or playing a game on the mobile device. This capability extends the ease of use and enhances the quality of user experiences by offering increased mobility for these applications. Further enhancements to these capabilities would prove beneficial to the art.

### SUMMARY

Embodiments of the present disclosure provide a communications system, a method of operating a communications system and a method of fulfilling mobile applications.

In one embodiment, the communications system includes a mobile device that is coupled to a network and has a mobile application requiring fulfillment, and a personal computer that is coupled to the network and has computer data entry and display capabilities. Additionally, the communications system includes a mobile applications processor that is coupled to the personal computer and provides a mobile device interaction, wherein the mobile device interaction includes fulfillment of the mobile application with the computer data entry and display capabilities.

In another aspect, the method of operating a communications system includes coupling a network to a mobile device having a mobile application requiring fulfillment and coupling the network to a personal computer having computer data entry and display capabilities. The method also includes providing a mobile device interaction with a mobile applications processor coupled to the personal computer, wherein the mobile device interaction includes fulfilling the mobile application employing the computer data entry and display capabilities.

In yet another aspect, the method of fulfilling mobile applications includes providing a mobile device application requiring fulfillment to a network and coupling the mobile device application from the network to computer data entry and display capabilities. The method also includes fulfilling the mobile device application employing the computer data entry and display capabilities.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

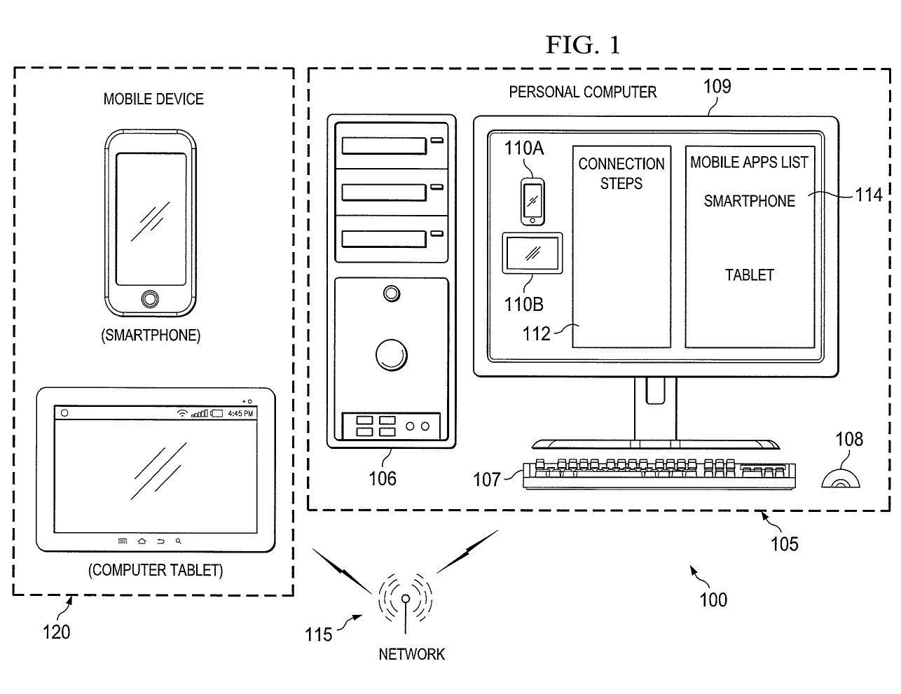

FIG. 1 illustrates a diagram of an embodiment of a communications system constructed according to the principles of the present disclosure;

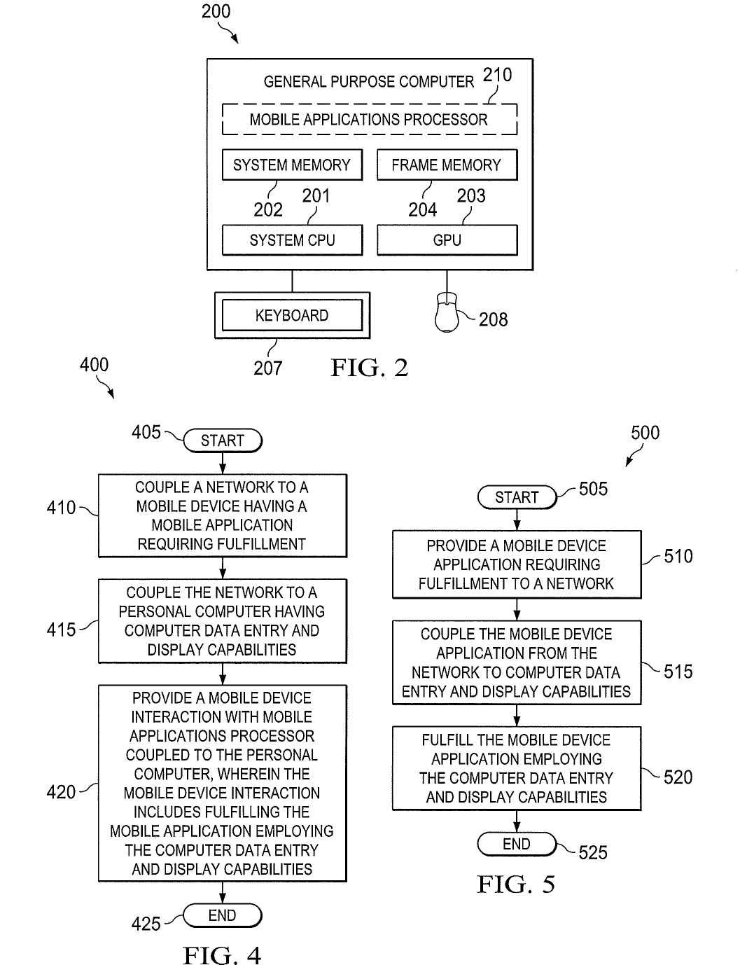

FIG. 2 illustrates a block diagram of an embodiment of a general purpose computer as may be employed in FIG. 1 and constructed according to the principles of the present disclosure;

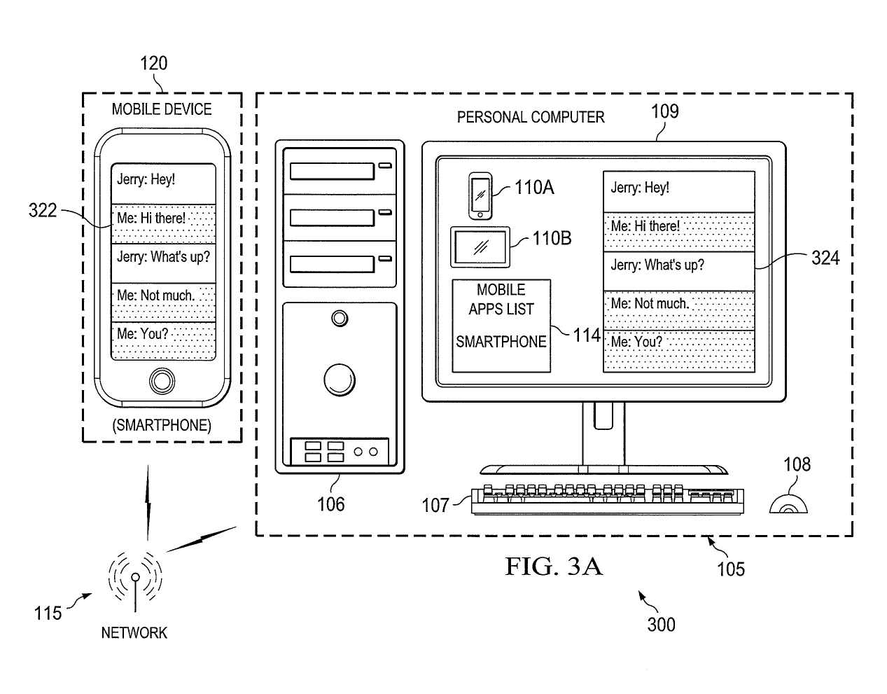

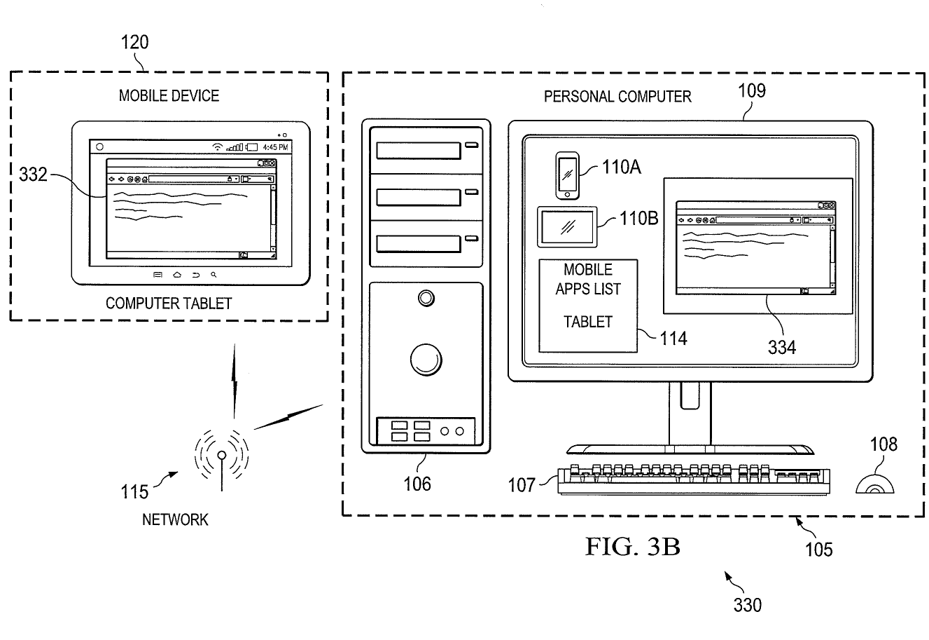

FIGS. 3A and 3B illustrate mobile device application examples employing a communications system as is generally described in FIG. 1;

FIG. 4 illustrates a flow diagram of an embodiment of a method of operating a communication system carried out according to the principles of the present disclosure; and

FIG. 5 illustrates a flow diagram of an embodiment of a method of fulfilling mobile applications carried out according to the principles of the present disclosure.

### DETAILED DESCRIPTION

Embodiments of the present disclosure allow a personal computer user to access a mobile device, such as a smartphone or a computer tablet, from the computer and interact with the mobile device. Advantages include providing mobile device application formats, information or notifications that may be fulfilled through display and data entry capabilities associated with the personal computer. For purposes of the present disclosure, a personal computer is defined as a computer employing general purpose computing capabilities that may be a desktop or notebook computer, wherein these capabilities make it broadly and directly operable by a user to fulfill software applications, which may include word processing, databases, spreadsheets, presentations, Internet browsing, e-mail and gaming, for example. Additionally, the personal computer may employ wired or wireless connections to local networks that include a local area network (LAN) or a wireless local area network (WLAN or WI-FI network).

FIG. 1 illustrates a diagram of an embodiment of a communications system, generally designated 100, constructed according to the principles of the present disclosure. The communications system 100 includes a personal computer 105, a network 115 and a mobile device 120. Generally, the mobile device 120 is coupled to the network 115 and has a mobile application requiring fulfillment. Examples for the mobile device 120 are shown that correspond to a mobile phone (i.e., a smartphone) and a tablet (i.e., a computer tablet) which may typically have touch screens for mobile data entry and display capabilities. The personal computer 105 is also coupled to the network 115 and employs a general purpose computer 106 having computer data entry and display capabilities in the form of a keyboard 107, a computer mouse 108 and a monitor 109. The general purpose computer 106 is also coupled to a mobile applications processor that is discussed more specifically with respect to FIG. 2.

FIG. 2 illustrates a block diagram of an embodiment of a general purpose computer, generally designated 200, as may be employed in FIG. 1 and constructed according to the principles of the present disclosure. In the illustrated embodiment, the general purpose computer 200 includes a system central processing unit (CPU) 201, a system memory 202, a graphics processing unit (GPU) 203, a frame memory 204, a computer keyboard 207 and a computer mouse 208 serving as a computer pointing device. The general purpose computer 200 also includes a mobile applications processor 210.

The system CPU 201 is coupled to the system memory 202 and the GPU 203 and provides general computing processes and control of operations. The system memory 202 includes long term memory storage (e.g., a hard drive) for computer applications and random access memory (RAM) to facilitate computation by the system CPU 201. The GPU 203 is further coupled to the frame memory 204 and provides monitor display and frame control of a monitor, such as the monitor 109 of FIG. 1.

The mobile applications processor 210 is generally indicated as coupled to the general purpose computer 200. In one embodiment, the mobile applications processor 210 is a software module and may operationally reside in the system memory 202, the frame memory 204 or in portions of both. Alternately, the mobile applications processor 210 may be implemented in hardware or a combination of software and hardware.

The mobile applications processor 210 is coupled within the general purpose computer 200 to provide a mobile device interaction, wherein the mobile device interaction includes fulfillment of the mobile application with the computer data entry and display capabilities indicated with respect to FIGS. 1 and 2. Additionally, the mobile device interaction may include contact initiation or termination with the mobile device and information reception (e.g., mobile application information) from the mobile device or information transmission (e.g., mobile application fulfillment information) to the mobile device.

Referring again to FIG. 1, the network 115 is a local network that is representative of a WI-FI network or a local area network (LAN). Here, coupling to the network 115 is wireless and employed to gain access to the mobile device 120 and provide a mobile device interaction, which typically uses the keyboard 107, the computer mouse 108 and the monitor 109.

Examples of establishing the wireless connections to the network 115 include establishing a peer-to-peer connection employing the WI-FI network or using a streaming protocol with the LAN, where both the personal computer 105 and the mobile device 120 are logged onto the network 115. For the peer-to-peer connection, a standard such as the Miracast Wireless Display Specification may be employed. The Miracast Wireless Display Specification is an open, wireless display specification developed by the Wi-Fi Alliance, which facilitates sharing photos, replaying high definition video content or playing 3D computer games by streaming them to an external display from a resident computer. The specification relies on the Wi-Fi direct stack to establish the peer to peer connection between the personal computer 105 and the mobile device 120 without the need to go through a WI-FI access point or router. This approach requires that both the personal computer 105 and the mobile device 120 be Miracast enabled.

The communications system 100 also includes first and second mobile device icons 110A, 110B on the display of the monitor 109 that may be employed to initiate or conclude mobile device interactions with the smartphone or tablet, respectively. Of course, other icons may be employed that correspond to other mobile devices, or a universal icon may be employed, where appropriate.

The communications system 100 further includes a connections menu 112 that lists steps in a connection process between the personal computer 105 and the mobile device 120. In one example, the connections menu 112 is minimized until an appropriate mobile device icon is activated. Upon activation, the connections menu 112 is maximized on the display to provide user instructions.

An example sequence of steps is described in the following.
1) A computer user clicks on an appropriate mobile device icon (e.g., icon 110A indicating a smartphone).
2) The computer user is instructed to enable the smartphone to initiate a wireless connection to the network 115.
3) The computer user supports connection of the smartphone (e.g., enters credentials for authentication, etc.).
4) The smartphone streams a mobile application requiring fulfillment to the personal computer 105 over the network 115.
5) The mobile application appears on the display of the monitor 109 (e.g., it may be displayed as a phone screen user interface, as discussed in FIG. 3A, or it may be cataloged in a mobile applications list 114 for follow-on action).
6) The computer user interacts with the smartphone application on the monitor 109 employing the keyboard 107 and the computer mouse 108.
7) The computer user again clicks on the icon 110A to disconnect or suspend the network connection when the mobile device interactions are complete.
   In other embodiments of the present disclosure, connection and disconnection of the mobile device 120 and the personal computer 105 to the network 115 are accomplished automatically through a mobile applications processor.

FIGS. 3A and 3B illustrate mobile device application examples employing a communications system, generally designated 300, 330, as is generally described in FIG. 1. In the communications system 300, the mobile device 120 is a mobile phone (i.e., a smartphone) having a touch screen used for mobile data entry and display capabilities. The smartphone is displaying a TEXT (i.e., Small Message Service) message 322 and the monitor 109 is displaying a TEXT message representation 324 of the TEXT message 322. The TEXT message representation 324 is employed to fulfill this mobile application for the smartphone.

Correspondingly, in the communications system 330, the mobile device 120 is a computer tablet also having a touch screen used for mobile data entry and display capabilities. The computer tablet is displaying an e-mail message 332 and the monitor 109 is displaying an e-mail message representation 334 of the e-mail message 332. The e-mail message representation 324 is employed to fulfill this mobile application for the computer tablet. As noted, TEXT and e-mail messages are just examples of mobile applications requiring fulfillment, and additional current or future mobile applications requiring fulfillment or mobile device interactions are included in the scope of the present disclosure.

FIG. 4 illustrates a flow diagram of an embodiment of a method of operating a communication system, generally designated 400, carried out according to the principles of the present disclosure. The method 400 starts in a step 405, and a network is coupled to a mobile device having a mobile application requiring fulfillment, in a step 410. Then, the network is coupled to a personal computer having computer data entry and display capabilities, in a step 415. A mobile device interaction is provided with a mobile applications processor coupled to the personal computer, wherein the mobile device interaction includes fulfilling the mobile application employing the computer data entry and display capabilities.

In one embodiment, providing the mobile device interaction includes one selected from the group consisting of initiating or terminating contact with the mobile device and accessing or providing mobile device information.

Correspondingly, providing the mobile device interaction includes employing an icon on the personal computer display. In another embodiment, fulfilling the mobile application includes one selected from the group consisting of an e-mail interaction and a Short Message Service (SMS) interaction.

In yet another embodiment, coupling the network includes coupling to a local area network. Alternately, coupling the network includes coupling to a Wi-Fi network. Correspondingly, coupling to the Wi-Fi network includes forming a peer-to-peer network connection between the mobile device and the personal computer. Accordingly, the mobile device and the personal computer conform to the Miracast Wireless Display Specification. The method 400 ends in a step 425.

FIG. 5 illustrates a flow diagram of an embodiment of a method of fulfilling mobile applications, generally designated 500, carried out according to the principles of the present disclosure. The method 500 starts in a step 505, and a mobile device application requiring fulfillment is provided to a network, in step 510. Then, the mobile device application is coupled from the network to computer data entry and display capabilities, in a step 515. The mobile device application is fulfilled employing the computer data entry and display capabilities, in a step 520.

In one embodiment, fulfilling the mobile device application includes providing and coupling the mobile device application to a local area network or a Wi-Fi network. In another embodiment, fulfilling the mobile device application includes forming a peer-to-peer network connection between the mobile device application and the computer data entry and display capabilities. Correspondingly, the mobile device application and the computer data entry and display capabilities respectively correspond to a mobile device and a personal computer that conform to the Miracast Wireless Display Specification. The method 500 ends in a step 525.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A communications system, comprising:
a mobile device that is coupled to a network and has a mobile application requiring fulfillment;
a personal computer that is coupled to the network and has computer data entry and display capabilities; and
a mobile applications processor that is coupled to the personal computer and provides a mobile device interaction, wherein the mobile device interaction includes fulfillment of the mobile application with the computer data entry and display capabilities.

2. The system as recited in claim 1 wherein the mobile device interaction includes one selected from the group consisting of:
contact initiation or termination with the mobile device; and
information reception or transmission for the mobile device.

3. The system as recited in claim 1 wherein the mobile device interaction includes employing an icon on the personal computer display.

4. The system as recited in claim 1 wherein the mobile application includes one selected from the group consisting of:
an e-mail interaction; and
a Short Message Service (SMS) interaction.

5. The system as recited in claim 1 wherein the network is a local area network.

6. The system as recited in claim 1 wherein the network is a Wi-Fi network.

7. The system as recited in claim 6 wherein the Wi-Fi network includes a peer-to-peer network connection between the mobile device and the personal computer.

8. The system as recited in claim 7 wherein the mobile device and the personal computer comply with the Miracast Wireless Display Specification.

9. A method of operating a communications system, comprising:
coupling a network to a mobile device having a mobile application requiring fulfillment;
coupling the network to a personal computer having computer data entry and display capabilities; and
providing a mobile device interaction with a mobile applications processor coupled to the personal computer, wherein the mobile device interaction includes fulfilling the mobile application employing the computer data entry and display capabilities.

10. The method as recited in claim 9 wherein providing the mobile device interaction includes one selected from the group consisting of:
initiating or terminating contact with the mobile device; and
accessing or providing mobile device information.

11. The method as recited in claim 9 wherein providing the mobile device interaction includes employing an icon on the personal computer display.

12. The method as recited in claim 9 wherein fulfilling the mobile application includes one selected from the group consisting of:
an e-mail interaction; and
a Short Message Service (SMS) interaction.

13. The method as recited in claim 9 wherein coupling the network includes coupling to a local area network.

14. The method as recited in claim 9 wherein coupling the network includes coupling to a Wi-Fi network.

15. The method as recited in claim 14 wherein coupling to the Wi-Fi network includes forming a peer-to-peer network connection between the mobile device and the personal computer.

16. The method as recited in claim 15 wherein the mobile device and the personal computer comply with the Miracast Wireless Display Specification.

17. A method of fulfilling mobile applications, comprising:
providing a mobile device application requiring fulfillment to a network;
coupling the mobile device application from the network to computer data entry and display capabilities; and
fulfilling the mobile device application employing the computer data entry and display capabilities.

18. The method as recited in claim 17 wherein fulfilling the mobile device application includes providing and coupling the mobile device application to a local area network or a Wi-Fi network.

19. The method as recited in claim 17 wherein fulfilling the mobile device application includes forming a peer-to-peer network connection between the mobile device application and the computer data entry and display capabilities.

20. The method as recited in claim 19 wherein the mobile device application and the computer data entry and display capabilities respectively correspond to a mobile device and a personal computer that comply with the Miracast Wireless Display Specification.
